(19) United States
(12) Patent Application Publication
(10) Pub. No.: US 2023/0135288 A1
(43) Pub. Date: May 4, 2023

(54) Methods For Parallel And Personalized Education

(71) Applicant: Technica Pacifica LLC, Incline Village, NV (US)

(72) Inventors: Brian Holt, Incline Village, NV (US); Sam Elhag, San Diego, CA (US)

(73) Assignee: Technica Pacifica LLC, Incline VIllage, NV (US)

(21) Appl. No.: 17/974,445

(22) Filed: Oct. 26, 2022

Related U.S. Application Data
(60) Provisional application No. 63/273,831, filed on Oct. 29, 2021.

(51) Int. Cl. G09B 19/00

(52) U.S. Cl. CPC G09B 19/00; G09B 3/02

(57) ABSTRACT

A computer-implemented method for generating a personalized educational item is disclosed herein. A personalization engine (1003) personalizes instruction and assessment for a student based on student interests, preferences, needs, answers, data, social network, and similar personal information. The personalization engine (1003) replaces a contextual image placeholders with context fragments (1006) embodied as images related to the selected context (1005).

### CROSS REFERENCE TO RELATED APPLICATION

The present application claims priority to U.S. Provisional Patent Application No. 63/273,831, filed on Oct. 29, 2021, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention generally relates to educational instruction and assessment.

### Description of the Related Art

Modern education is evolving from a cohort paradigm to a personal paradigm. Traditionally, students were grouped by age and location into a class and each class was given a uniform curriculum. This cohort method was largely a product of contemporary technologies and resource limitations. While resource efficient, cohort education targets the needs of the average student and to some degree neglects the needs of both the advanced and trailing students.

With advances in computing and telecommunications, personalized education is now practical. The present invention describes novel methods by which educational instruction and assessment can be efficiently and effectively personalized for students, allowing them to learn at their uniquely optimal pace, at their appropriate level, using contexts they specifically find engaging.

### BRIEF SUMMARY OF THE INVENTION

The present invention is termed Parallel and Personalized (PaPer) education.

A first aspect of the present invention is a method to personalize instruction and assessment for a student based on student interests, preferences, needs, answers, data, social network, and similar personal information.

A second aspect of the present invention is adapting instruction and assessment items for students with learning disabilities and/or special needs.

A third aspect of the present invention is individualizing assessment questions for improved validity and quality according to Item Response Theory (IRT), Classical Test Theory (CTT), and similar psychometric models.

A fourth aspect of the present invention is a print-to-digital cycle wherein a computer program recommends an educational print item (e.g. worksheet) according to a student's computer-interfaced assessment. Optionally the educational print item is printed locally by the teacher or student; or alternatively the educational print item is printed by a service that physically mails the item to the teacher or student.

A fifth aspect of the present invention is a computer program enabling a teacher to print personalized worksheets for a student.

A sixth aspect of the present invention is assessment data recorded on the blockchain.

A seventh aspect of the present invention is an assessment-item recommendation cycle in a computer application, wherein a student completes an educational item, then takes an assessment, and is presented with a next educational item according to the assessment score.

Another aspect of the present invention is a computer-implemented method for generating a personalized educational item. The method includes receiving a context selection from a plurality of possible context selections. The method also includes accessing a media item associated with the context selection. The method also includes accessing an educational item. The method also includes combining the media item and the educational item to form a personalized educational item. The method also includes presenting the personalized educational item to the user.

Yet another aspect of the present invention is a computer-implemented method for generating a personalized educational item. The method includes receiving a plurality of social network connections for a user, each connection comprising at least a name. The method also includes accessing an educational item. The method also includes combining the educational item and at least one name of one social network connection of the plurality of social network connections to form a personalized educational item. The method also includes presenting the personalized educational item to the user.

Yet another aspect of the present invention is a computer-implemented method for generating a combined educational item. The method includes assessing a user on a first subject. The method also includes assessing a user on a second subject. The method also includes selecting a first educational item related to the first subject according to the results of assessing the user on the first subject. The method also includes selecting a second educational item related to the second subject according to the results of assessing the user on the second subject. The method also includes combining the first educational item and the second educational item into a combined educational item. The method also includes presenting the combined educational item to the user.

Yet another aspect of the present invention is a computer-implemented method for generating a combined educational item. The method includes assessing a user on a first subject. The method also includes assessing a user on a second subject. The method also includes selecting a first educational item related to the first subject according to the results of assessing the user on the first subject. The method also includes selecting a second educational item related to the second subject according to the results of assessing the user on the second subject. The method also includes combining the first educational item and the second educational item into a combined educational item. The method also includes presenting the combined educational item to the user.

Yet another aspect of the present invention is a non-transitory computer-readable storage medium storing program instructions which cause a computer processor to generate a personalized educational item by: receiving a plurality of social network connections for a user, each connection comprising at least a name; accessing an educational item; combining the educational item and at least one name of one social network connection of the plurality of social network connections to form a personalized educational item; and presenting the personalized educational item to the user.

Yet another aspect of the present invention is a non-transitory computer-readable storage medium storing program instructions which cause a computer processor to generate a combined educational item by: assessing a user on a first subject; assessing a user on a second subject; selecting a first educational item related to the first subject according to the results of assessing the user on the first subject; selecting a second educational item related to the second subject according to the results of assessing the user on the second subject; combining the first educational item and the second educational item into a combined educational item; and presenting the combined educational item to the user.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 illustrates one embodiment wherein a personalization engine personalizes an educational item according to the student's selected context preference.

FIG. 1A illustrates one example of FIG. 1 using a baseball context for a math assessment item.

FIG. 2 illustrates one embodiment wherein the personalization engine personalizes an educational item according to the student's previous answers.

FIG. 3 illustrates one embodiment wherein the personalization engine personalizes an educational item according to the student's data, for example, demographic data.

FIG. 4 illustrates one embodiment wherein the personalization engine personalizes an educational item according to the student's social network data.

FIG. 5 illustrates one embodiment wherein the personalization engine personalizes an instruction recommendation according to the student's social network data.

FIG. 6 illustrates one embodiment wherein the personalization engine personalizes an assessment question format according to the student's disability data.

FIG. 7 illustrates one embodiment wherein structured data is converted into narrative text.

FIG. 8 illustrates one embodiment of a gradebook-style report of normalized answers to one question on an assessment.

FIG. 9 illustrates one embodiment wherein an assessment question is personalized for each of a group of students, then results are normalized in a report.

FIG. 10 illustrates a cycle of assessment to educational item.

FIG. 11 illustrates a student assessment recorded on a blockchain.

FIG. 12 illustrates an instruction-assessment cycle in an education application.

FIG. 13 illustrates a computer program personalizing an educational print item for a student.

FIG. 14 illustrates an assessment-recommendation-personalization cycle.

FIG. 15 illustrates a multisubject assessment-recommendation-combination cycle.

### DETAILED DESCRIPTION OF THE INVENTION

Those skilled in the art will recognize these drawings provide only a few illustrative examples of possible embodiments of the present invention. These embodiments are optionally combined, in part or in whole. Elements of these drawings are conceptual representations of computer processes which those skilled in the art will recognize as a combination of computer software and hardware. Certain similar elements are given the same reference number across figures, those skilled in the art will recognize that aspects of these elements may differ somewhat according to the needs of the particular embodiment.

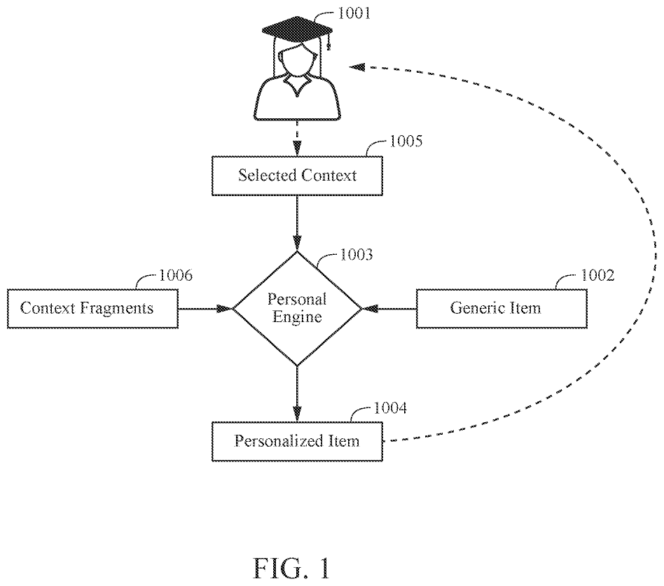

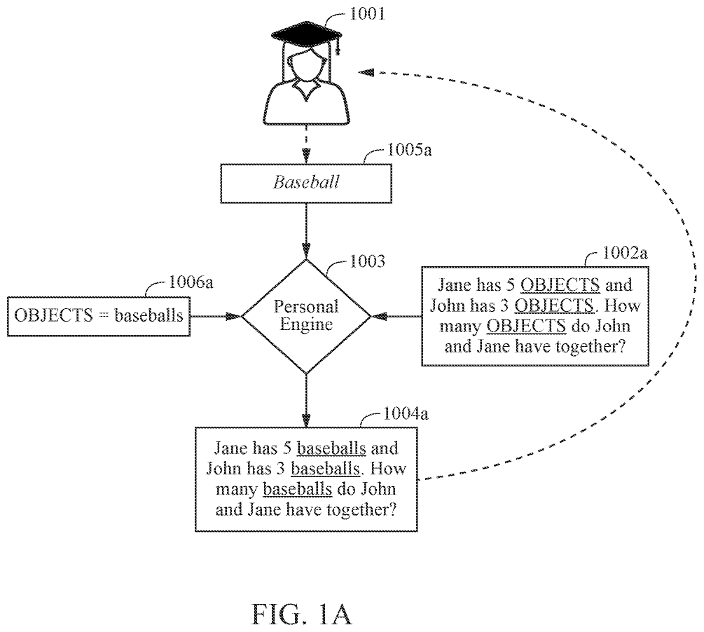

FIG. 1 illustrates one embodiment wherein a student 1001 selects a context 1005. The personalization engine 1003 uses this selection to combine a generic educational item 1002 with context fragments 1006 to form a personalized educational item 1004 that is then presented to the student 1001.

The selected context 1005 is typically a topic the student has an affinity toward, such as baseball or space exploration. In one embodiment, the student selects a context 1005 using a software application on a computing device such as a desktop, laptop, tablet, or mobile phone. In an alternate embodiment, the student communicates a context selection 1005 to a teacher, orally or in writing, who then enters that context into a computing device.

The generic education item 1002 is optionally an electronic assessment question, an electronic lesson (optionally comprising text, audio, video, or interactive media), a print assessment question, a print worksheet, or other print item. The generic education item 1002 comprises a contextual fragments which the personalization engine 1003 replaces with context fragments 1006 according to the selected context 1005. Contextual fragments are optionally in the medium of text, image, audio, video, games, virtual reality objects, or other media.

The present invention preferably comprises a database of context fragments 1006, each associated with one or more selectable contexts 1005 and a medium such as text, image, audio, virtual reality, augmented reality, or video.

In one embodiment, the generic educational item 1002 is a text assessment question. The personalization engine 1003 replaces a contextual phrases with context fragments 1006 embodied as text phrases related to the selected context 1005. For example, a text generic education 1002 item may contain the a contextual fragment OBJECTS which the personalization engine 1003 replaces with the context fragment 1006 baseballs.

In another embodiment, the generic educational item 1002 is a lesson in a multimedia application such as a website or a tablet application. The personalization engine 1003 replaces a contextual image placeholders with context fragments 1006 embodied as images related to the selected context 1005. For example, a text generic education 1002 item may contain an a contextual fragment indicating a 200×200 pixel image which the personalization engine 1003 replaces with the context fragment 1006 of an image of a baseball. In one embodiment, the personalization engine alters the SRC attribute of an <IMG> HTML, tag or similar.

In another embodiment, the generic educational item 1002 is a lesson in a multimedia application such as a website or a tablet application. The personalization engine 1003 directs the student's user interface to download and play a context fragment 1006 embodied as a video related to the selected context 1005. For example, the student's application downloads and plays baseball.mp4.

In another embodiment, the generic educational item 1002 is a print worksheet. The personalization engine 1003 replaces a contextual image placeholders with context fragments 1006 embodied as images related to the selected context 1005. The worksheet is optionally in HTML, PDF, DOC, or similar format.

In one embodiment, the personalized educational item 1004 is presented to the student 1001 electronically in a software application such as a web browser, native computer application, tablet application, or mobile phone application; in an alternate embodiment the personalized educational item 1004 is presented to the student 1001 on a print medium such as paper. Optionally the print item is physically mailed to the student 1001.

The personalization engine 1003 is a combination of computer hardware and software programmed to personalize student assessments and/or instructions. Optionally, the personalization engine 1003 is embodied on a network server. Optionally, the personalization engine 1003 is embodied on a cloud server such as those offered by Amazon Web Services, Google Compute Engine, or Microsoft Azure. In one embodiment, the student 1001 use a computer user interface (e.g. web browser or mobile application) that accesses the personalization engine 1003 over a network connection (e.g. the Internet) through an Application Programming Interface (API). Optionally the personalization engine 1003 is embodied on a personal computing device such as a desktop computer or laptop computer. Optionally the personalization engine is embodied on a mobile computing device such as an Apple iPhone, Apple iPad, Microsoft Surface tablet, Android tablet, or Android phone.

In one embodiment, the student 1001 selects multiple contexts 1005, each associated with a distinct context fragment 1006, and each combined with the generic education item 1002. For example, the student selects a context 1005 of baseball and a of elephants and the personalized item 1004 comprises images of elephants playing baseball.

The present invention is optionally applied to academic tests including the Scholastic Assessment Test (SAT), American College Testing (ACT), Law School Admission Test (LSAT), Graduate Record Examination (GRE), Graduate Management Admission Test (GMAT), and similar tests.

FIG. 1A illustrates one example of FIG. 1 wherein a student 1001 selects a context of Baseball 1005A. The personalization engine 1003 then combines a generic text assessment question 1002A with a context fragment 1006A associated with the Baseball context to form a personalized assessment question 1004A that is present to the student 1001.

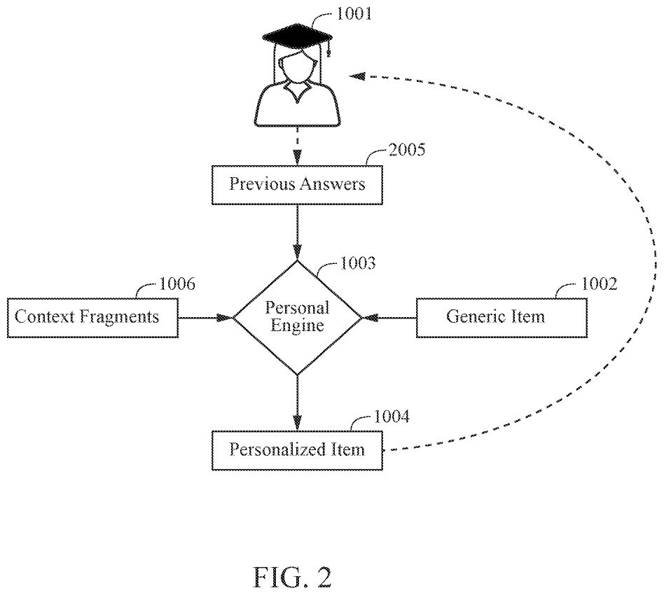

FIG. 2 illustrates one embodiment wherein a student's 1001 previous answers to questions 2005 are used by the personalization engine 1003 to personalize an educational item 1002. The personalized educational item 1004 is displayed to the student. For example, the student has correctly answered previous questions about baseball more often than previous questions about football, therefore the personalization engine personalizes the next question to be about baseball.

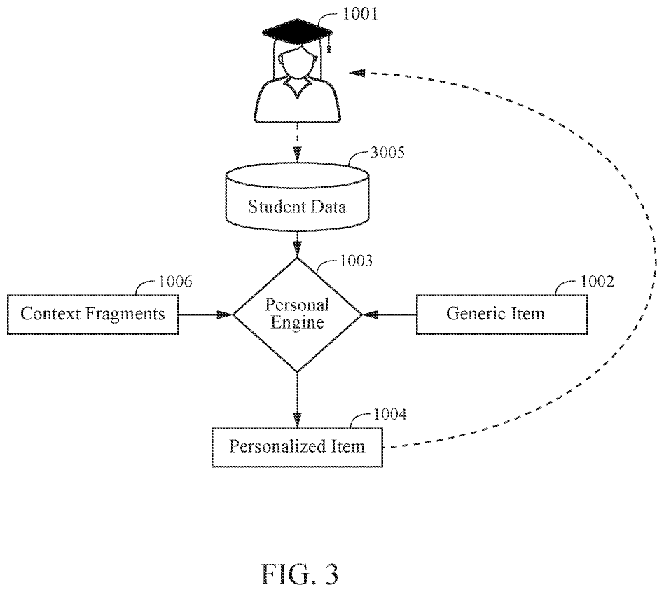

FIG. 3 illustrates one embodiment wherein a student's 1001 data 3005 is used by the personalization engine 1003 to personalize an educational item 1002. Student data 3005 optionally includes demographic information such as age, gender, ethnicity, race, socioeconomic status, and parental status. Student data 3005 optionally includes linguistic characteristics such as native language and English Language Learner (ELL) status. Student data 3005 optionally includes diagnoses for disorders such as dyslexia, dyspraxia, dyscalculia, dysgraphia, autism, attention deficit disorder (ADD/ADHD), or other diagnosis. Optionally, student data 3005 is determined by a human. Optionally, student data 3005 is determined algorithmically, including algorithmic analysis of previous answers and application usage.

In one embodiment, the personalization engine 1003 uses student data 3005 to guess student interest and personalize a question accordingly. For example, the personalization engine knows the student is a 10-year-old male that lives in Oakland, Calif., and therefore guesses the student has an interest in the Oakland Athletics baseball team, and therefore references the Oakland Athletics in an assessment question. Optionally, the data-to-interest guess is made according to statistical or machine learning analysis of other students' data-to-interest data. Optionally, student interests are associated with brands engaged in promotions and/or partnerships with the entity implementing the present invention.

In one embodiment, the personalization engine 1003 personalizes characters in educational items to match the demographic information of a student, including race and gender. In another embodiment, the student 1001 is presented with instruction/assessment items concerning an intimate partnership between two characters. The personalization engine 1003 personalizes the pronouns and partner titles of the characters according to student data 3005 such as the student's sexual orientation.

The data source for student data 3005 is optionally a learning management system (LMS) or student information system (SIS).

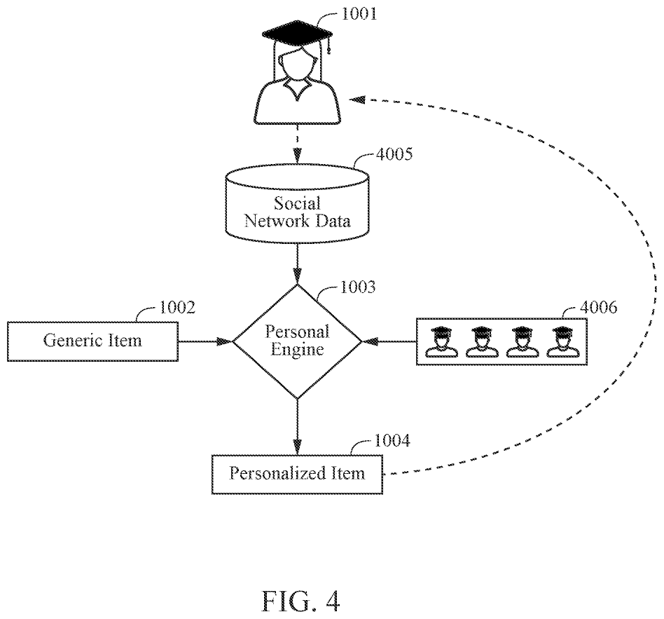

FIG. 4 illustrates one embodiment wherein a student's 1001 social network data 4005 is used by the personalization engine 1003 to generate a personalized item 4002 from a generic item 1002. The student's social network data is based on connections to other students 4006.

Optionally, social network data 4005 comprises connections within an educational software application. For example, a mobile application implementing the present invention allows students to connect to each other, wherein these connections provide the social network data 4005. Alternatively, social network data comes from an authority grouping students, for example, a K-12 school grouping students into a class. Optionally, social networking data comes from a service primarily designed for social networking such as Facebook, Twitter, or TikTok. Typically, social network data 4005 is stored in a database on an internet server and accessed by a client application such as a tablet application.

Social network data 4005 optionally includes the names of connected persons, activities of connected persons, pictures of connected persons, text written by connected persons (e.g. blog posts), online educational activities of connected persons, and other data stored in the social network related to connected persons.

Optionally, social networked students' pictures or avatars are integrated into educational items.

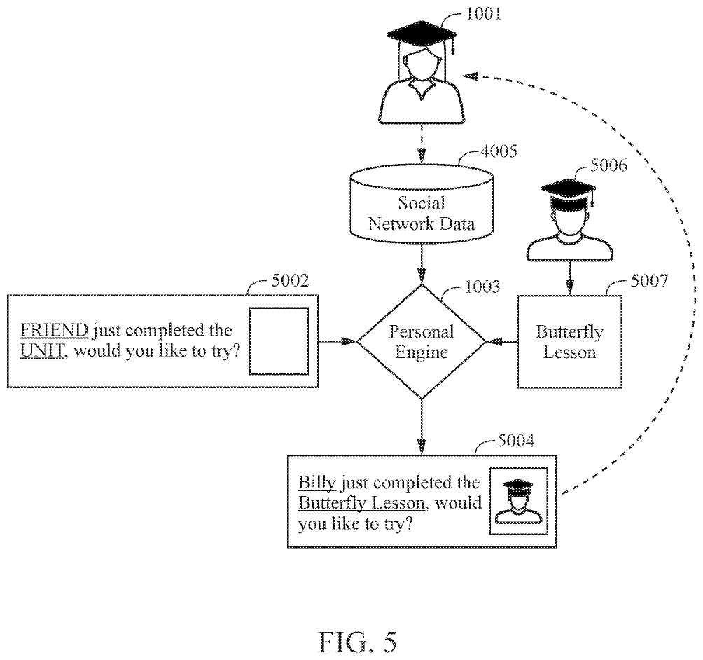

FIG. 5 illustrates one embodiment wherein a personalization engine 1003 recommends a lesson based on a student's 1001 social network data 4005. A second student 5006 is connected to the first student's 1001 social network. The second student 5006 completes an education unit titled Butterfly Lesson 5007. The personalization engine 1003 determines that the first student might benefit from the lesson 5007. In a computer user interface, the personalization engine 1003 prompts the first student 1001 with a message 5004 recommending the lesson 5007. The message 5004 is personalized with the name of the second student 5006, a picture of the second student 5006, and the name of the lesson 5007.

Optionally, the message is conveyed by emphasizing the lesson in a list of lessons, for example, placing an icon next to the recommended lesson. Optionally, the message is framed competitively, for example, “Billy completed this lesson in three minutes, can you beat his time?”

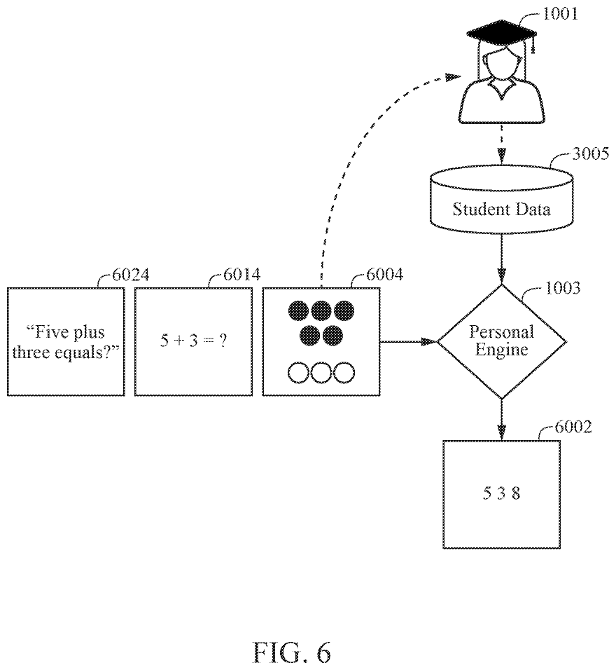

FIG. 6 illustrates one embodiment wherein a student's 1001 data 6005 is used by the personalization engine 1003 to personalize a generic assessment question 6002 into a formatted assessment question 6004. In one embodiment, the generic assessment question 6002 is adapted to the special needs of a student with a learning disability. The generic question 6002 is associated with a plurality of presentation formats (6004, 6014, 6024). Optionally, the generic question 6002 contains information that will be presented to the student. Alternatively, the generic question 6002 is an identifier associated with the formatted questions (6004, 6014, 6024). The first formatted question 6024 is audio. The second formatted question 6014 is written numerals. The third formatted question 6004 is visual. The personalization engine 1003 delivers the third formatted question 6004 to the student 1003. Optionally formatted instruction is delivered. Optionally, the delivered formatted question is selected from one or more static files. Optionally, the delivered formatted question is dynamically generated.

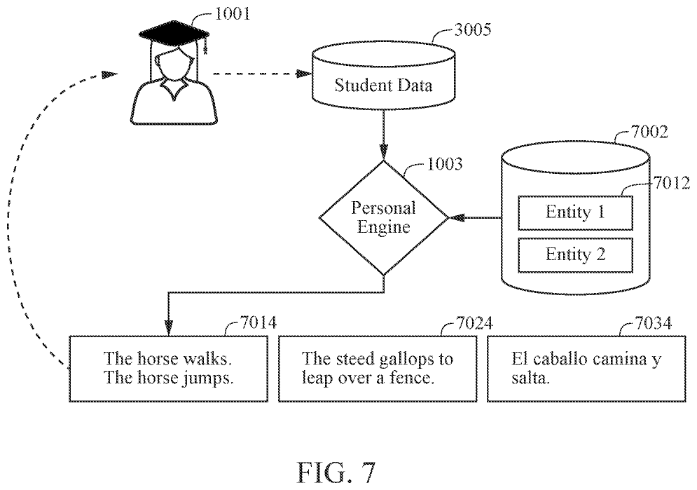

FIG. 7 illustrates one embodiment wherein structured data 7002 is transfigured to narrative text 7014. The personalization engine 7003 selects entities 7012 from structured data 7002. The structured data 7002 stores data points (e.g. subjects, objects, modifiers, actions) about a narrative in non-natural-language form. The personalization engine 7003 transfigures the selected entities to natural language text 7014 according to relevant student data 3005 (e.g. previous answers or demographic data). In one embodiment, the personalization engine 7003 transfigures the entities into basic reading level English text 7014. In another embodiment, for a student learning a foreign language, the personalization engine 7003 transfigures the entities into foreign language text such as Spanish 7034.

As the student's reading abilities improve over time, the personalization engine repeats the question to the student transfigured into progressively higher reading levels 7024. This allows for analysis of one student's progress at multiple points in time, while also allowing for a comparison between multiple students at one time.

Optionally, a plurality of entities is transfigured to narrative text and displayed in one instance, such as in multiple sentences or multiple paragraphs. Optionally, entries are transfigured to narrative text and displayed sequentially, such as displaying one sentence or paragraph per screen. Optionally, the personalization engine personalizes text according to the student's relative language proficiency, be it a native or foreign language. Optionally, the personalization engine personalizes text according to the Lexile framework from MetaMetrics, or similar.

Optionally, the narrative comprises multimedia such as audio, video, virtual reality (VR), or image.

In one embodiment, the structured data is stored as JavaScript Object Notation (JSON). In another embodiment, structured data is stored as Yet Another Markup Language (YAML). In another embodiment, the structured data is stored in a relational database. Optionally, each entity is a database row.

In one embodiment, entities comprise a combination of structured syntax and natural language. For example, an entity might comprise “The [horse/steed] [walks/gallops].” This example associates synonymic words at different reading levels. Optionally, entities contain identifiers associated with human-readable words stored elsewhere.

In one embodiment, entities are stored as tuples. For example, a tuple represented in JSON-like syntax might be:

```
{
  object: [ horse, steed ],
  verb: [ walk, gallop ]
}
```

Optionally, entities comprise identifiers associated with words stored elsewhere. For example, the entity comprises an object ID associated with a tuple storing multiple synonyms for the desired object word:

```
{
  object: 1234,
  . . .
}
{
  id: 1234,
  en_l1: horse,
  en_l2: steed,
  es_l1: caballo
}
```

In one embodiment, the structured data entities are derived from a pre-existing text, such as a novel or short story. Optionally, the entities are derived by applying natural language processing or a neural network to a pre-existing text. For example, a natural language processor is applied to Shakespeare's Romeo and Juliet, whereby an entity representing the character of Romeo and an entity representing the character of Juliet are extracted and stored in structured data.

In one embodiment, a student is presented with natural language text. The student is presented with a prompt to enter one or more pieces of information conveyed by the natural language text as structured text. The computer programmatically verifies the structured data.

In another embodiment, structured data stores characters, locations, and times. Media (including natural language text, images, and/or video) is presented to the user. The media communicates a narrative personalized according to the user's selection. In one embodiment, the user selects a character and the media communicates a narrative of period of time in the character's life according to the structured data points related to that character. Optionally, the character is a historical figure and the data points relate to historical events—such as battles of Julius Caesar. In another embodiment, the user selects a location and a media narrative is constructed describing events which occurred in that location. For example, the user selects Paris, France and a narrative communicates chronologically great artists that have lived in Paris.

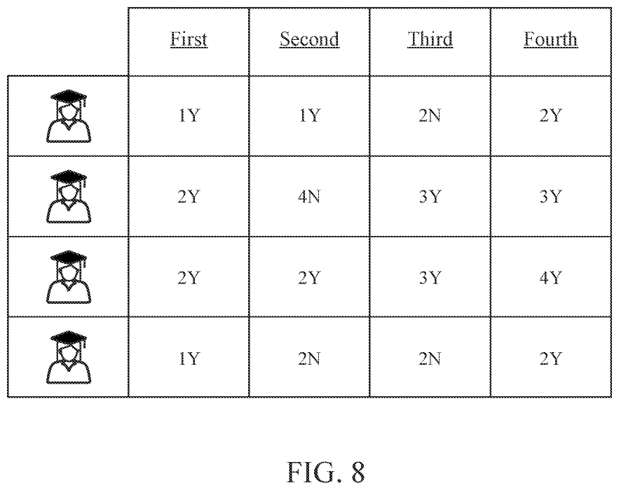

FIG. 8 illustrates a normalized report for answers to one assessment question. The report is laid out as a gradebook. Each row represents a student 8001. Each column represents an assessment 8002 of the given question. Each center cell 8003 represents a normalized form of the student's answer to the question. In this embodiment, each student answered the question four times, over a period of time, each time the question was personalized to the student's reading level. Each answer starts with a 1-4 indicating the reading level of each question, followed by a Y for a correct answer or an N for an incorrect answer. Ideally, as a student progresses, they are presented with the same question personalized to increasingly higher reading levels. Rows indicate a student's progress over time. Columns indicate a cohort's abilities at a point in time. Answers are optionally represented on a number rubric, for example 1-4. Answers are optionally represented with letters, such as A-D. Answers are optionally represented as a percentage 0-100%. Answers are optionally color coded. Optionally, each answer cell represents a plurality of answers from an assessment.

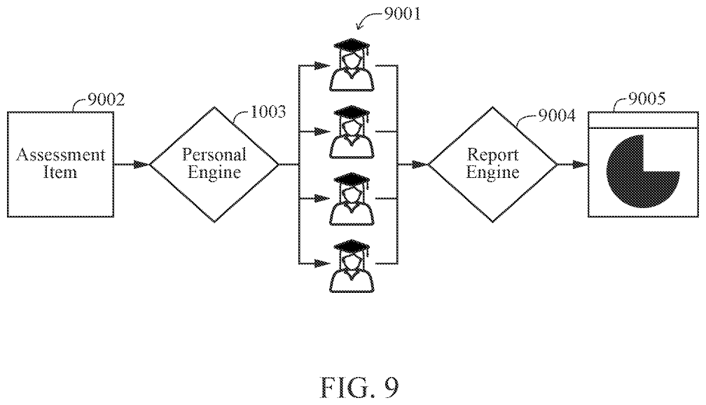

FIG. 9 illustrates one embodiment wherein an assessment question 9002 is personalized by the personalization engine 1003 for each of a group of students 9001. The answers are then normalized by a reporting engine 9004 to display a report 9005. While each student answers a differently worded question, the system identifies that the knowledge demonstrated by each answer is comparable.

In one embodiment, the personalization engine 1003 or the report engine 9004 applies a psychometric analysis to the answers (such as IRT) and adjusts the questions according. Optionally, the adjustment comprises modifying the question or possible answers. Optionally, the adjustment comprises removing a certain question from the assessment. Optionally, the adjustment comprises discounting a question from students' overall scores. Optionally, the adjustment is made automatically; alternatively, an adjustment recommendation is presented to the teacher. Optionally, the application of psychometric analysis comprises the use of neural networks, machine learning, and/or artificial intelligence.

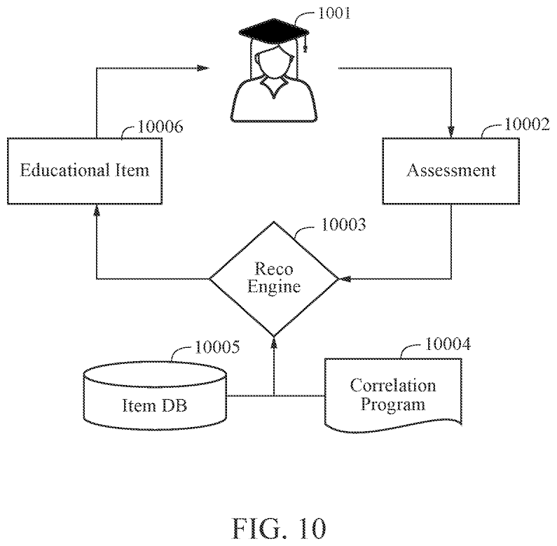

FIG. 10 illustrates a cycle of computer assessment to educational item. A student 1001 completes an assessment 10002 in a computer interface such as a web browser or tablet application. The student's answers are processed by a recommendation engine 10003, which then recommends the next educational item 10006 to either the student directly, or to a teacher to give to the student.

The recommendation engine 10003 comprises a combination of computer hardware and software, including a database of recommendable items 10005 and a correlation program 10004 that correlates answers (correct or incorrect) with recommendable items. In one embodiment, the correlation program 10004 comprises an algorithm written in conventional computer programming language. In another embodiment, the correlation program 10004 comprises a neural network. In another embodiment, the correlation program 10004 comprises a Bayesian algorithm. In one embodiment, the logic of the correlation program 10004 is derived manually by a human entering correlations; optionally, a human manually tags questions and items with educational standard codes such as those of Common Core. In another embodiment, the logic of the correlation program 10004 is derived computationally from previous students' answers; optionally using statistical analysis or neural network training (optionally including backpropagation). In another embodiment, the logic of the correlation program 10004 is a combination of the above.

In one embodiment, the educational item 10006 is a print item, such as a worksheet. In one embodiment, the student 1001 (or teacher) prints the item locally. In another embodiment, the item 10006 is printed by a service provider and physically mailed to the student 1001. This embodiment forms a print-to-digital loop wherein the student benefits from having a permanent digital assessment history and a computer recommendation engine, but also receives offline educational content so they are not required to excessively stare at a computer screen. Offline items are optionally scanned or photographed to be stored in a digital student portfolio. Items in the portfolio are optionally graded by computer vision and/or character recognition.

In another embodiment, the education item 10006 is digital media presented electronically such as an audio file (such as MP3), a webpage (such as HTML), video file (such as MP4), image file (such as JPEG), multimedia application (such as Flash or iOS app), a slideshow (such as PPT), or a document (such as PDF or DOC).

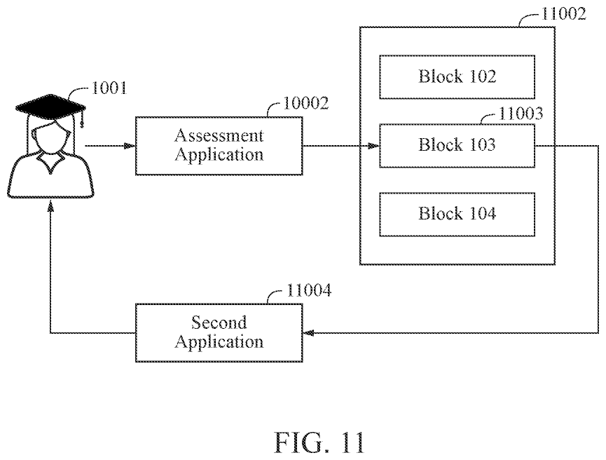

FIG. 11 illustrates a student assessment recorded on a blockchain. A student 1001 completes an assessment 10002 on a computer application. The computer application sends data packets over a computer network comprising data related to the student's assessment score and a cryptographic identifier. Typically, the cryptographic identifier comprises a public key, private key, cryptographic signature, or an associated string/integer. The packets are received by a network node participating in a blockchain 11002. Information related to the student's assessment score and cryptographic signature are sent to other network nodes participating in the blockchain 11002 and the information is cryptographically written to a blockchain block 11003. A second educational application 11004 uses a student identifier (typically associated with a public key) to read the student's assessment score from the blockchain 11002. The second educational application 11004 uses this score to present appropriate assessment, instruction, curriculum, courses, rewards, or other educational items to the student 1001.

In one embodiment, the student 1001 earns on-blockchain rewards for completing assessments, such as tokens, cryptocurrency, or nonfungible tokens (NFTs).

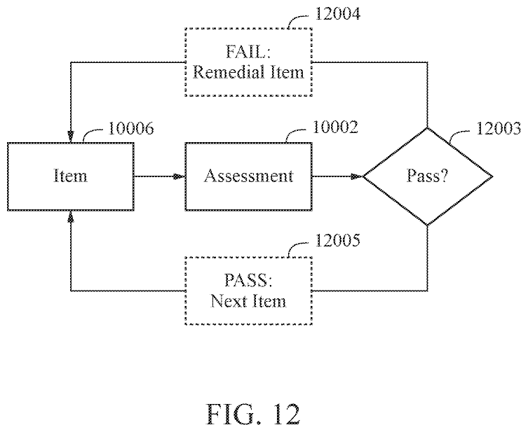

FIG. 12 illustrates item-assessment cycle logic in an educational application. Optionally, this logic is used in the recommendation engine 10003 in FIG. 10. A student accesses a computer application such as a web browser, desktop program, iOS application, Android application, tablet application, mobile phone application, or similar. The application displays an educational item 10006 to the student, for example a video about dinosaurs. The application then presents the student with an assessment 10002 related to the item 10006, for example asking multiple choice or fill-in-the-blank questions about dinosaurs. The student answers the assessment questions. The application determines if the student passes the assessment 12003. If PASS 12005, the application presents the student with the next item. If FAIL 12004, the application presents the student with a remedial item. The cycle then restarts. In one embodiment, the application presents a general remedial item indicating that that the student did not pass the assessment. In another embodiment, the application presents a remedial item based on one or more selected incorrect answers, wherein the item specifically addresses the student's presumed incorrect thought process. In another embodiment, the application redisplays the initial item as the remedial item. In another embodiment, the application displays a combination of the remedial items described above.

In one embodiment, the item 10006 is a narrative video and the assessment 10002 is personalized to match the video narrative.

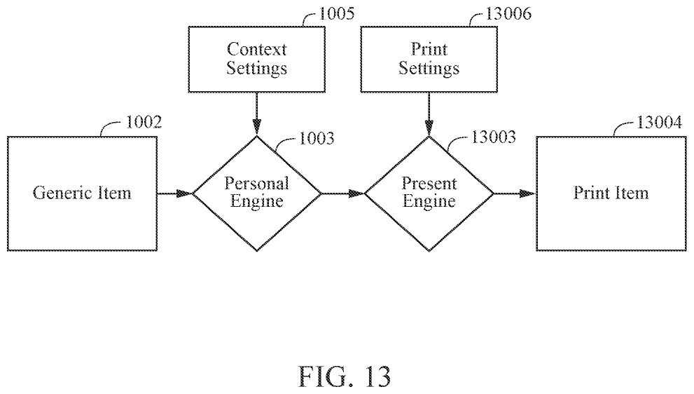

FIG. 13 illustrates a computer program personalizing a educational print item for a student. A computer accesses a generic education item 1002, for example a printable worksheet. Optionally, the item 1002 is selected by a student/teacher in a graphical user interface. At block 1003, the personalization engine combines the generic item 1002 with an appropriate context settings 1005, for example baseball or dinosaurs. At block 13003, the presentation engine uses printer settings 13006 (for example full color, grayscale, minimal black-and-white) to modify the generic item 1002 or subselect an associated generic item matching the print settings 13006. At block 13004 the computer program generates a print item which is then printed using an electronic computer printer. In one embodiment, the computer program stores default context settings 1005 and print settings 13006 for the user so that the user need not reselect those upon every printing. Optionally, user default settings are stored in a web browser cookie, local computer storage, or in a server database row associated with the user's account.

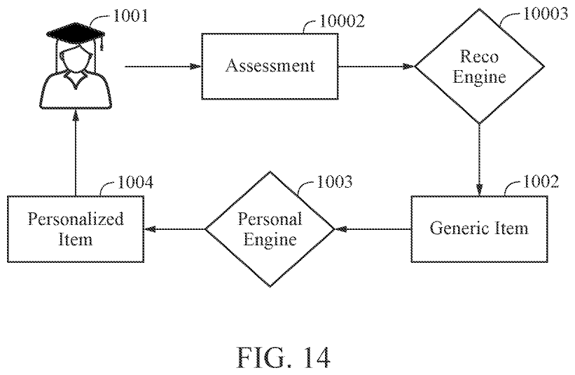

FIG. 14 illustrates an assessment-recommendation-personalization cycle. A student 1001 completes an electronic assessment 10002. Based on the assessment score, a recommendation engine 10003 selects an appropriate generic educational item 1002. The generic educational item is personalized 1003. The personalized item 1004 is presented to the student. The student 1001 completes the personalized item 1004 and the cycle starts again. In one embodiment, the personalized item 1004 is a print item such as a worksheet or workbook. Optionally, the print item is printed on a home printer, or alternatively, printed by a service that mails the item to the student. Optionally, the mailing is done periodically, such as weekly, monthly, or quarterly.

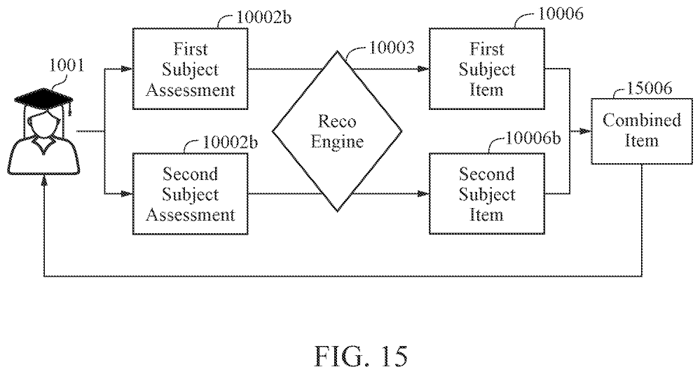

FIG. 15 illustrates a multisubject assessment-recommendation-combination cycle. A student 1001 is assessed on a first subject 10002. A recommendation engine 10003 processes the student's answers to select an appropriate first subject item 10006 according to the student's assessed knowledge of the first subject. The student 1001 is assessed on a second subject 10002B. The recommendation engine 10003 processes the student's answers to select a second subject item 10006B according to the student's assessed knowledge of the second subject. The first subject item 10006B and the second subject item 10006B are combined to form a combined item 15006 that is presented to the student.

Example subjects include addition, algebra, astronomy, biology, calculus, division, history, language, math, multiplication, physics, reading, subtraction, trigonometry, writing, and similar.

In one embodiment, the assessment comprises two events, one for each subject. In another embodiment, the assessment comprises one event which assesses the students on both subjects; for example, alternating questions between math and language.

In one embodiment, the combined item 15006 is printed on a print medium.

In one embodiment, two subject files are combined into one file before printing; for example, an addition worksheet PDF file is combined with a language fill-in-the-blank worksheet PDF file to form a printable combined workbook PDF file. Optionally, the combined item 15006 is printed locally by the student or teacher; alternatively, the combined item 15006 is printed by a service that physically mails the combined item 15006 to the student or teacher.

In another embodiment, two subject files are each sent electronically to a printing service that prints both and bundles them into one combined package, which is then mailed to the student; for example, the printing service prints an addition worksheet PDF file, then prints a language fill-in-the-blank worksheet PDF, then places the two in an envelope to be mailed to the student. In this embodiment, the package constitutes a combined item 15006. Packages include envelopes, boxes, folders, binders, and similar.

### PREFERRED COMPONENTS OF THE INVENTION

The following are some of the preferred components variously used in certain embodiments of the present invention. Additional components not listed here are used in certain embodiments.

Application Programming Interface (API) is a connection between computer programs wherein one program offers a known a service to another program. API programs may be located on the same computer, or may be located on disparate computers connected by a network. An example network API design is REST.

Assessment is the process of evaluating a student's subject knowledge. A typical assessment is in a question-answer form such as multiple choice or fill-in-the-blank. Assessments may be administered orally, in writing, or on a computing device (e.g. a desktop or tablet). A placement assessment is typically administered in the beginning of a term in order to select a curriculum or class for a student. A formative assessment is typically administered periodically intraterm in order to assess the student's progress. A summative assessment is typically administered at the end of a term to formally determine a student's progress over the term. Specific assessments may be required by certain authorities, for example state standardized tests such as California's Standardized Testing and Reporting (STAR); or college admissions tests such as the Scholastic Assessment Test (SAT), American College Testing (ACT), Law School Admission Test (LSAT), Graduate Record Examination (GRE), or Graduate Management Admission Test (GMAT).

Audio computer file formats include 3GP, AA, AAC, MP3 OGG, WAV, WMA, WEBM, and similar.

Blockchain is a list of records linked cryptographically and stored on a computer network. Constituent records are called blocks and typically comprise a cryptographic hash of the previous block and a timestamp. Example blockchains include Bitcoin, Ethereum, Polygon, Binance, Ripple, Cardano, Solana, Polkadot, Near, Avalanche, Litecoin, Monero, Arbitrum, Optimism, Lightning Network, and similar. Blockchains known as Layer-1 blockchains exists independently, blockchains known as Layer-2 are dependent on Layer-1 blockchains.

Blockchain smart contract is a computer program that is automatically executed by nodes of a blockchain network. Example blockchains that utilize smart contracts include Ethereum and Solana.

Blockchain address is a string associated with a public-private keypair for a user on a blockchain. Blockchain addresses are commonly represented as hexadecimal strings such as 0x1234ABC. Blockchain smart contracts are typically assigned a unique blockchain address to which users send messages to execute the program.

Blockchain token or coin or loosely cryptocurrency is a mathematical representation of asset ownership on a blockchain. Example Ethereum token types include ERC-20 fungible tokens, ERC-721 non-fungible tokens, and ERC-1155 semi-fungible tokens. Creation of a token is termed minting, destruction of a token is termed burning.

Bonding Curve is a mathematical concept used to describe the relationship between price and the supply of an asset.

Cascading Style Sheets (CSS) is a style sheet language used for describing the presentation of a document written in a markup language such as HTML.

Classical test theory (CTT) is an approach that is based on simple mathematics; primarily averages, proportions, and correlations.

Client is a computer initiating a request to a server computer over a network.

Cloud computing is a method of granting on-demand control of a computer to a user over a network.

Cloud provider is a legal person offering cloud computing. Example cloud providers include Amazon Web Services, Google Cloud, and Microsoft Azure.

Cloud storage is a special case of cloud computing focused on offering on-demand storage and network transmission of data.

Code generator is a computer program that receives a specification and outputs a computer program. The output program may be encoded in a programming language, assembly language, machine code, object code, byte code, or other binary code.

Common Core is a set of US K-12 educational standards for math and language arts detailed at www.corestandards.org.

Computer, or computing device or computing system, is a physical device comprising at least one computer-readable storage medium and at least one processor. A computer typically operates by reading input data from a computer-readable storage medium, reading instructions from a computer readable storage medium, and executing the input data and instructions with the processor to produce output data. Output data is typically stored in a computer-readable storage medium and/or outputted to a user. Computer form factors include desktops, laptops, smart phones, smart watches, and servers.

Computer-readable storage medium (CRSM), or computer data storage medium, or storage, is a physical device containing input data and/or instructions for use by a computer. Common CRSMs include hard drives (HDD), solid state drives (SSD), flash drives, tape drives, magnetic tape, Compact Discs (CD), Digital Video Discs (DVD), Blue-rays, optical drives, floppy disks, zip drives, random access memory (RAM), read only memory (ROM), and punch cards.

Context is media associated with an educational item. Example contexts include: athletes, baseball, basketball, buildings, celebrities, dinosaurs, equipment, fairy tales, farm animals, fictional animals (e.g. unicorns), fictional characters, fictional locations, fictional stories, football, geographic locations, heavy machinery, historical figures, insects, occupations, outer space, planets, religious figures, religious iconography, rockets, soccer, sports, stars, tennis, wild animals, zoo animals, and similar.

Create/Read/Update/Delete (CRUD), or manipulate, are the four basic operations on stored data. In SQL, these terms map to INSERT, SELECT, UPDATE, and DELETE. In HTTP, these terms map to POST, GET, PUT, DELETE.

Cryptography is the practice and study of techniques for secure communication in the presence of adversarial behavior. In computer science, common cryptographic techniques include Diffie-Hellman, X.509, Rivest-Shamir-Adleman (RSA), and Elliptic-curve cryptography (ECC), and Elliptic Curve Digital Signature Algorithm (ECDSA).

Database (DB), or computer database, is an organized set of data stored on a computer-readable storage medium for manipulation by a database program.

Database Management System (DBMS), or database program or database software, is a special case program to manipulate a database. Example database management systems include MySQL, Microsoft Access, SQLite, PostgreSQL, MariaDB, Couchbase, Redis, MongoDB, and HBase.

Database cell, or cell, is the value of one row at one column in a database table.

Database column, or column, is a set of values of a particular type, with each row having one value per column in a table.

Database row, or row or tuple, is an entry in a database table comprising one value per column of the table.

Domain name is an identification string that defines a realm of administrative authority within the Internet. Domain names are used in various networking contexts and for application-specific naming and addressing purposes. Generally, a domain name points to a server at a given IP address. An example domain name is namechain.com.

Domain Name System (DNS) is a hierarchical and decentralized naming system for computers, services, or other resources connected to the Internet or a private network. DNS is associated with internet protocols including DNS, DNS-over-UDP, DNS-over-TCP, DNSCrypt, DNS-over-TLS, DNS-over-HTTPS, DNS-over-TOR, and Oblivious DNS-over-HTTPS.

Domain name record is a record associated with a domain name, including nameserver records, DNS records, Auth Codes, registrant information, registrant account identifiers, and WHOIS records.

Download is the transmission of data from a server computer to a client computer over a network.

Educational item is a text block, worksheet, book, web page, video file, audio file, app screen, document, virtual reality object, multimedia file, or other medium used to instruct or assess a student.

Ethereum Improvement Proposal (EIP) is a prefix for Ethereum standards, followed by a number, such as EIP-165.

Ethereum Request for Comments (ERC) is a prefix for Ethereum standards, followed by a number, such as ERC-20.

ERC-20 is a free, open standard that describes how to build fungible tokens on the Ethereum blockchain.

ERC-721 is a free, open standard that describes how to build non-fungible or unique tokens on the Ethereum blockchain.

ERC-1155 is a free, open standard that describes how to build semi-fungible or unique tokens on the Ethereum blockchain.

Ethereum is a blockchain network with smart contract functionality developed in 2014 by Vitalik Buterin and others.

Ethernet is a family of wired computer networking technologies commonly used in local area networks (LAN), metropolitan area networks (MAN) and wide area networks (WAN).

Extensible Provisioning Protocol (EPP) is an XML-based protocol designed for domain registrars to update domain name records in the domain name registry.

Evidence-based education (EBE) is the principle that education practices should be based on the best available scientific evidence, rather than tradition, personal judgement, or other influences.

Flashcard, or flash card, is a card bearing information on both sides, which is intended to be used as an aid in memorization. Digital flashcards typically simulate this idea by using two screens: a front screen and a back screen.

Hardware, or computer hardware, is the collection of physical devices comprising a computer.

Hash function, or hash, is a function that converts input data of arbitrary size to an output value of fixed size. Hashes are often used in checksums, check digits, fingerprints, lossy compression, randomization functions, error-correcting codes, and ciphers. Hashes may be implemented by software, hardware, or both. Example hash functions include Keccak, Secure Hash Algorithm (SHA), Message-Digest Algorithm 5 (MD5), RIPE Message Digest (RIPEMD), Whirlpool, BLAKE, and Cyclic Redundancy Check 32 (CRC32).

HTTP cookie, or cookie, is a piece of data stored on a client computer used for storing state information when communicating with a server. Typically, cookies are handled by web browsers.

Hyperpiler is a code generator described in U.S. Pat. No. 10,942,709 and related documents.

Hyperplexer is a multitenant server described in U.S. patent application Ser. No. 17/542,442 and related documents.

Hyper Text Markup Language (HTML), is the standard markup language for displaying documents in a web browser.

Image computer file formats include BMP, GIF, JPEG, PNG, SVG, and similar.

Input device is a physical device which initiates a computer execution. Such execution includes storing data, storing instructions, and/or selecting instructions and data to execute in the future. Input devices include computer keyboards, keypads, computer mice, touch screens, microphones, cameras, card readers, scanners, bar code readers, chip readers, magnetic tape readers, network modem (wired or wireless), and Bluetooth receiver.

Internet is the global system of interconnected computer networks that uses the TCP/IP protocol to communicate.

Internet Protocol Address (IP address). A unique number identifying a computer connected to the Internet. Internet Protocol version 4 (IPv4) addresses comprise 32 bits. Internet Protocol version 6 (IPv6) addresses comprise 128 bits.

Item Response Theory (IRT) is a paradigm for the design, analysis, and scoring of assessments.

Linux is a family of open-source Unix-like operating systems based on the Linux kernel first released on Sep. 17, 1991, by Linus Torvalds.

Likert scale is a psychometric scale commonly involved in research that employs questionnaires.

Markup language is a syntax for annotating a document in a way that is visually distinguishable from the content. Markup languages typically do not contain executable instructions. Example markup languages include HTML, LaTeX, and Markdown.

Microprocessor is a special case processor that converts a digital electric input signal into a digital electric output signal through a clock-driven integrated circuit comprising logic gates. Example commercial microprocessors include the Intel 4004, the Intel Pentium line, the IBM PowerPC line, the and the Motorola 68000.

Multimedia file includes DOC, PDF, PPT, FLV, HTML, and similar.

Network is two or more computers comminating. Network data may be sent as electric pulses over copper wire, light pulses over optical fiber, and/or radio waves over the air.

Network protocol is a predefined signal syntax allowing two computers to communicate over a network. Protocols may be implemented by software, hardware, or both. Protocols are typically “layered,” wherein more specific protocols are transmitted within more generic protocols. Example protocols include Address Resolution Protocol (ARP), Internetwork Packet Exchange (IPX), Transmission Control Protocol (TCP), Internet Protocol (IP), User Datagram Protocol (UDP), HyperText Transfer Protocol (HTTP), Secure Socket Layer (SSL), Transport Layer Security (TLS), File Transport Protocol (FTP), Secure File Transport Protocol (SFTP), Secure Shell (SSH), Telnet, Domain Name System (DNS). Internet Control Message Protocol (ICMP), NetBIOS, Remote Procedure Call (RPC), Internet Relay Chat (IRC), Network Time Protocol (NTP), Internet Message Access Protocol (IMAP), Post Office Protocol (POP), and Simple Mail Transfer Protocol (SMTP).

Network router, or router, is a networking device that forwards data packets between computer networks. A router may itself be a computer.

Network switch, or switch or switching hub or bridging hub, is a networking device that connects other devices on a computer network by using packet switching to receive and forward data to the destination device.

Non-Fungible Token (NFT) is a unique and non-interchangeable unit of data stored on a blockchain. NFTs use a digital ledger to provide a public certificate of authenticity or proof of ownership. The lack of interchangeability (fungibility) distinguishes NFTs from blockchain cryptocurrencies, such as Bitcoin.

Open source describes a software program that is made freely available for possible modification and redistribution.

Personalization is the process of modifying education items to meet the learning needs, preferences, and interests of a student. Both instruction and assessment items may be personalized. Personalization encompasses contextualization, differentiation, and/or individualization. This includes modifying themes such as astronomy, sports, animals, music, movies, geography ecology, colors, and technology; difficulty such as reading level; presentation such as words, numbers, or symbols; names such as the student's name or student's friends' names; and media such as text, audio, video, image, and virtual reality.

Print medium, or print media or print item, is an object with physical markings. Markings are typically made by a computer-connected printer. Markings typically comprise letters, numbers, or graphics. Print media includes paper sheets, books, booklets, flashcards, plastic sheets, trading cards, playing cards, folders, binders, worksheets, workbooks, magazines, comic books, newspapers, and similar.

Processor is a physical device that deterministically executes input signals into output signals. Signals are typically electric. Signals may be digital or analog.

Program, or computer program or computer application or application or piece of software or app, is a distinct document of software. A program may reference and execute other programs. Example programs include Microsoft Word, WordPress, Apple iOS, and SQLite.

Program specification, or specification, is a data document describing the desired function of a computer program. A specification is typically processed by a code generator to output a computer program. Example specification encoding syntaxes include UML, XML, and JSON.

Programming Language is a formal language comprising a set of strings that instruct a computer processor. There are a number of programming languages, each having a specific syntax to encode instructions. Programming languages are typically compiled to machine code for execution at the processor. Example programming languages include: ASP, BASIC, C, C#, C++, COBOL, Erlang, Go, Haskell, Java, JavaScript, Lisp, Objective-C, Perl, Python, PHP, Ruby, Rust, Scala, Solidity, and Vyper.

Psychometrics is a field of study within psychology concerned with the theory and technique of measurement.

Relational Database Management System (RDBMS) is a special case database management system using tuple principles.

Representational state transfer (REST) is an API design in which a client sends an HTTP request to a server which responds with structured data in XML, JSON, similar format.

Scaling, in social science, is the process of measuring or ordering entities with respect to quantitative attributes or traits.

Server, or web server or network server, is a special case computer optimized for receiving requests and sending responses over a computer network.

Simple Query Language (SQL) is a domain-specific computer language for manipulating data in a relational database management system.

Social networking service, or social network, is a computer program storing relationships between users, typically including features such as messaging, blogging, or picture uploading. Such services include Blogger, Chess.com, ClassDojo, Discord, Facebook, GitHub, Instagram, Medium, Pintrest, Quora, Reddit, Remind, Snapchat, StackOverflow, Steam, Telegram, TikTok, Twitch, Twitter, WeChat, WhatsApp, Wikipedia, Yammer, YouTube, and similar.

Software, or computer software or computer code or code, is data and instructions stored on the computer-readable storage medium of a computer to be executed by the processor.

Solidity is a smart contract programming language widely used on the Ethereum network.

Spaced repetition is a learning technique whereby more difficult items are shown more frequently, while older and less difficult items are shown less frequently in order to exploit the psychological spacing effect. This method is often used with flashcards.

Spreadsheet is a document containing human-readable data structured in rows and columns.

Spreadsheet program is a special case program for manipulating spreadsheets.

Student is a person receiving knowledge. A student may attend preschool, K-12 school, university, college, vocational training center, or similar. A student may be a prisoner at a correctional facility. A student may be an employee, intern, contractor, or trainee at an organization. A student may be a customer of an organization. A student may be enrolled in a certification program. Alternate terms for student include pupil and learner.

Teacher is a person guiding a student's learning. A teacher may be employed as a preschool teacher, K-12 teacher, a K-12 administrator, a university professor, a researcher, a corrections officer, a corporate trainer, proctor, tutor, teaching assistant, or similar. A teacher may be a parent, grandparent, guardian, or similar. Alternate terms for teacher include instructor, educator, and professor.

Tuple is a data structure comprising a list of elements. Types of tuples include enumerated arrays.

Uniform Resource Locator (URL), or web address, is a reference to a web resource that specifies its location on a computer network and a mechanism for retrieving it. A typical URL has the form http://www.example.com/index.html, which indicates a protocol (http), a hostname (www.example.com), and a file name (index.html).

Unix is a family of multitasking, multiuser computer operating systems that derive from the original AT&T Unix, whose development started in the 1970s at the Bell Labs research center by Ken Thompson and Dennis Ritchie.

User is a distinct entity initiating an execution on a computer. Typically, a user is a human interacting with an input device. Alternatively, a user is a second computer programmed to interact with the first computer.

Vertical scaling is the process of placing scores from educational assessments measuring same/similar knowledge domains but at different ability levels onto a common scale.

Video computer file formats include 3GP, AVI, FLV, GIF, MOV, MP2, MP4, WEBM, WMV, and similar.

Virtual Machine is the virtualization/emulation of a computer system. Virtual machines are based on computer architectures and provide functionality of a physical computer. Their implementations may involve specialized hardware, software, or a combination.

Web browser, or browser or internet browser, is a program for browsing the World Wide Web. A typical browser function is to download and render a webpage comprising HTML, JavaScript, and/or CSS. Example web browsers include Microsoft Internet Explorer, Microsoft Edge, Google Chrome, Apple Safari, and Mozilla Firefox.

Web host is a special case cloud provider specializing in serving documents on the World Wide Web.

Web page, or webpage, is an HTML document on the World Wide Web.

Web site, or website, is a group of related web pages controlled by one legal person.

WHOIS is a query-response protocol for accessing public domain name information, including the registrar and the registrant.

Word processor is a program for humans to compose human-readable documents.

World Wide Web (WWW), or the web, is an information network of hyperlinked documents transmitted from web servers to client web browsers over the Internet using the HTTP protocol invented by Sir Timothy Berners-Lee in 1989 at CERN. Transmitted documents typically comprise HTML, CSS, and JavaScript.

Zero-Knowledge Proof or ZK proof is a method by which one party (the prover) can prove to another party (the verifier) that a given statement is true while the prover avoids conveying any additional information apart from the fact that the statement is indeed true. A non-interactive zero-knowledge proof requires no interaction between the prover and verifier. These cryptographic techniques are used to bundle transactions on blockchains. Examples include NIZK, zk-SNARK, and zk-STARK.

We claim as our invention the following:

1. A computer-implemented method for generating a personalized educational item, the method comprising:
receiving a context selection from a plurality of possible context selections;
accessing a media item associated with the context selection;
accessing an educational item;
combining the media item and the educational item to form a personalized educational item; and
presenting the personalized educational item to the user.

2. The computer-implemented method of claim 1, wherein presenting to the user comprises printing the personalized educational item on a printable medium.

3. The computer-implemented method of claim 2, further comprising printing the physical mailing address of the user on a printable medium.

4. The computer-implemented method of claim 1 wherein receiving a context selection from a plurality of possible context selections comprises receiving a plurality of social network connections for a user, each connection comprising at least a name; and wherein combining the media item and the educational item to form a personalized educational item comprises combining the educational item and at least one name of one social network connection of the plurality of social network connections to form the personalized educational item.

5. The computer-implemented method of claim 4, wherein the plurality of social network connections is received from the Application Programming Interface (API) of a social networking service.

6. A computer-implemented method for generating a combined educational item, the method comprising:
assessing a user on a first subject;
assessing a user on a second subject;
selecting a first educational item related to the first subject according to the results of assessing the user on the first subject;
selecting a second educational item related to the second subject according to the results of assessing the user on the second subject;
combining the first educational item and the second educational item into a combined educational item; and
presenting the combined educational item to the user.

7. The computer-implemented method of claim 6, wherein presenting to the user comprises printing the combined educational item on a printable medium.

8. The computer-implemented method of claim 7, further comprising printing the physical mailing address of the user on a printable medium.

9. A non-transitory computer-readable storage medium storing program instructions which cause a computer processor to generate a personalized educational item by:
receiving a context selection from a plurality of possible context selections;
accessing a media item associated with the context selection;
accessing an educational item;
combining the media item and the educational item to form a personalized educational item; and
presenting the personalized educational item to the user.

10. The non-transitory computer-readable storage medium of claim 9, wherein presenting to the user comprises printing the personalized educational item on a printable medium.

11. The non-transitory computer-readable storage medium of claim 10, further storing instructions for printing the physical mailing address of the user on a printable medium.

12. The non-transitory computer-readable storage medium of claim 9 wherein receiving a context selection from a plurality of possible context selections comprises receiving a plurality of social network connections for a user, each connection comprising at least a name; and wherein combining the media item and the educational item to form a personalized educational item comprises combining the educational item and at least one name of one social network connection of the plurality of social network connections to form the personalized educational item.

13. The non-transitory computer-readable storage medium of claim 12, wherein the plurality of social network connections is received from the Application Programming Interface (API) of a social networking service.

14. A non-transitory computer-readable storage medium storing program instructions which cause a computer processor to generate a combined educational item by:
assessing a user on a first subject;
assessing a user on a second subject;
selecting a first educational item related to the first subject according to the results of assessing the user on the first subject;
selecting a second educational item related to the second subject according to the results of assessing the user on the second subject;
combining the first educational item and the second educational item into a combined educational item; and
presenting the combined educational item to the user.

15. The non-transitory computer-readable storage medium of claim 14, wherein presenting to the user comprises printing the combined educational item on a printable medium.

16. The non-transitory computer-readable storage medium of claim 15, further storing instructions for printing the physical mailing address of the user on a printable medium.
